(19) United States
(12) Patent Application Publication
(10) Pub. No.: US 2011/0017742 A1
(43) Pub. Date: Jan. 27, 2011

(54) In-Groove Snap Fastener

(75) Inventors: Kari Ann Sausen, Clarence, NY (US); Steve M. Zielinski, N. Tonawanda, NY (US)

Correspondence Address: Delphi Technologies, Inc., M/C 480-410-202, P.O. Box 5052, Troy, MI, 48007, US

(73) Assignee: DELPHI TECHNOLOGIES, INC., Troy, MI (US)

(21) Appl. No.: 12/841,435

(22) Filed: Jul. 22, 2010

Related U.S. Application Data
(60) Provisional application No. 61/227,897, filed on Jul. 23, 2009.

(51) Int. Cl. B65D 45/16; F16B 17/00

(52) U.S. Cl. 220/324; 403/345; 403/364; 403/326

(57) ABSTRACT

An in-groove snap fastener for securely connecting two housing members and for providing a substantially air tight seal is disclosed. The in-groove snap fastener includes a first groove member and a second groove member extending from a first housing member defining a groove therebetween. One of the groove members includes a raised surface oriented toward the other groove member and the other groove member defines an aperture. A tab member having an integral tongue portion and a locking portion extends from a second housing member in the direction of the groove. The tongue portion cooperates with the raised surface to provide an interference fit between the groove members forming a substantially airtight seal. The raised surface also urges the locking portion to cooperate with the aperture to secure the first housing member to the second housing member.

### CROSS-REFERENCE TO RELATED APPLICATION

This application claims the benefit of U.S. Provisional Application No. 61/227,897, filed Jul. 23, 2009.

### TECHNICAL FIELD OF INVENTION

The present disclosure relates to fasteners for connecting two members; more particularly, to tongue and groove fasteners having a snap feature for connecting two housing members.

### BACKGROUND OF INVENTION

A typical housing assembly is produced by joining two or more housing members together. Conventional tongue and groove fasteners are commonly used to join and seal two housing members in a simple and effective manner. In a typical tongue and groove fastener, a tongue is provided along the joining surface of one housing member and a groove is provided along the corresponding joining surface of the other housing member. The joining surfaces of the housing members are aligned and then the tongue is inserted into the groove to connect and secure the housing members to form a complete housing assembly. For a non-pressurized housing assembly, the tongue and groove fastener may be adequate in maintaining the connection between the two housing members. However, for a pressurized housing assembly, a tongue and groove fastener alone may be not be sufficient. For example, during normal operating conditions, the interior air pressure of a heating, ventilating, and air conditioning (HVAC) housing may be greater than that of the ambient air pressure exterior of the housing. The greater interior air pressure acts upon the interior surfaces of the HVAC housing urging the housing members apart, thereby separating the tongue apart from the groove. The separation of the tongue from the groove may cause substantial air leaks, which could adversely affect the overall efficiency of the HVAC system, or even complete separation of the two housing members; thus requiring an additional fastener to work in conjunction with the tongue and groove fasteners to maintain a secure connection.

U.S. Pat. No. 5,699,601 issued to Gilliam et al. (Gilliam '601) discloses an external snap fastener used in conjunction with a tongue and groove fastener to connect a first housing member and to a second housing member forming an HVAC housing assembly. The tongue and groove fastener provides a substantially airtight seal, while the external snap fastener maintains the connection between the two housing members to prevent the tongue from separating from the groove. A drawback of an external snap fastener used in conjunction with a tongue and groove fastener is that the combination of the components lends itself to a complex and corpulent structure. The corpulent structure either reduces the capacity of the HVAC housing if the snap feature is located interior of the housing or reduces the packaging space if the snap feature is located on the exterior of the HVAC housing.

There is a long felt need for a fastener that has a compact structure, but yet capable of providing a robust connection between two housing members. There is a further need for a compact fastener that is capable of providing and maintaining a substantially air tight seal. There is still a further need for a compact fastener that allows the housing members to be easily assembled. Yet, there is still a further need for a compact fastener that is cost efficient and simple to manufacture.

### SUMMARY OF THE INVENTION

The present invention provides for an in-groove snap fastener for securely connecting two housing members and for providing a substantially air tight seal. The in-groove snap fastener includes a first groove member and a second groove member extending from a first housing member and defining a groove therebetween. One of the groove members includes a raised surface oriented toward the other groove member and the other groove member defines an aperture. A tab member having an integral tongue portion and a locking portion extends from a second housing member in the direction of the groove. The tab member is insertable into the groove, in which the tongue portion cooperates with the raised surface of the groove member to provide an interference fit between the groove members forming a substantially airtight seal. The raised surface also urges the locking portion of the tab member to cooperate with the aperture of the other groove member to secure the first housing member to the second housing member.

The tab member having the tongue portion integral with the locking portion disposed within a groove defined by the groove members (in groove) provides for a single fastener having both the functions of a tongue and groove fastener together with that of a snap fastener in a compact package.

The compactness of the in-groove snap fastener minimizes the reduction of HVAC housing capacity for improved overall HVAC performance, as well as cost savings from less material usage and reduction in manufacturing complexity. Further features and advantages of the invention will appear more clearly on a reading of the following detailed description of an embodiment of the invention, which is given by way of non-limiting example only and with reference to the accompanying drawings.

### BRIEF DESCRIPTION OF DRAWINGS

This invention will be further described with reference to the accompanying drawings in which:

FIG. 1 is shows a perspective view of a prior art tongue and groove fastener having an external snap fastener for connecting two housing members.

FIG. 2 shows a cross sectional view of the prior art fastener of FIG. 1 taken along section line 2-2

FIG. 3 shows a perspective view of two spaced apart housing members having an in-groove snap fastener in accordance with an embodiment of the invention.

FIG. 4 shows a perspective view of the housing members of FIG. 3 assembled together with the in-groove snap fastener locking the housing members in place.

FIG. 5 shows a cross-sectional view of the in-groove snap fastener prior to assembly taken along section line 5-5 of FIG. 3.

FIG. 6 shows the cross-sectional view of the in-groove snap assembly of FIG. 5, as the tab member is being inserted in the groove.

FIG. 7 shows the tab member of the second housing member fully inserted into the groove of the first housing, in which the tongue portion and locking portion of the tab member engage the groove members.

### DETAILED DESCRIPTION OF INVENTION

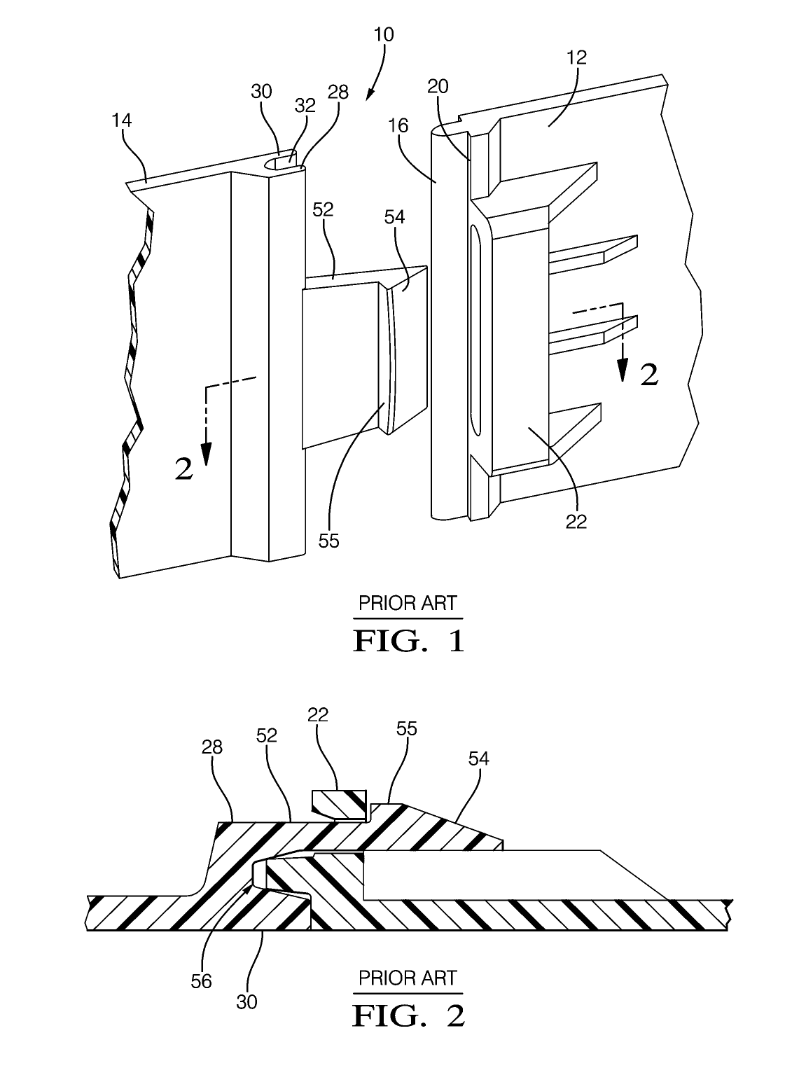

Shown in FIG. 1 is a perspective view of a prior art snap tab fastener 10 used to connect two housing members 12, 14 of an HVAC module. Show in FIG. 2 is a cross sectional view of the snap tab fastener 10 of FIG. 1 taken along section line 2-2. Best shown in FIG. 1, extending from the first housing member 12 is a tongue 16 together with a loop 22 positioned adjacent to and above the tongue 16. Extending from the second housing member 14 are first and second groove members 28, 30 defining a groove 32 therebetween. The groove 32 is oriented toward the first housing member 12 and is adapted to receive the tongue 16 extending from the first housing member 12 to form a substantially air tight seal. Extending from the first groove member 28 is a tab 52 that includes a locking member 55 having a tapered end 54. The tapered end 54 is adapted to elastically deform the loop 22 to position the locking member 55 to lock the tab 52 to the loop 22, thereby securing the first housing member 12 to the second housing member 14.

The tongue 16 and groove 32 provides a relatively air tight seal while the locking member 55 of the tab 52 provides a secure connection to maintain the integrity of the tongue 16 and groove 32 joint. A split tongue (not shown) is also known to be used to provide a more robust air tight seal. However, a drawback to the prior art snap tab fastener 10 is that the tab 52 is provided on the exterior of the tongue and groove joint 56; this is best shown in FIG. 2. A plurality of snap tab fasteners 10 is typically used to connect housing members to form an HVAC housing. The cumulative amount of volume occupied by the snap tab fasteners 10 either reduces the capacity of the HVAC housing if the tabs 52 of the snap tab fasteners 10 are located within the interior of the HVAC housing or reduces the amount of packaging space available if the tabs 52 are located on the exterior of the HVAC housing.

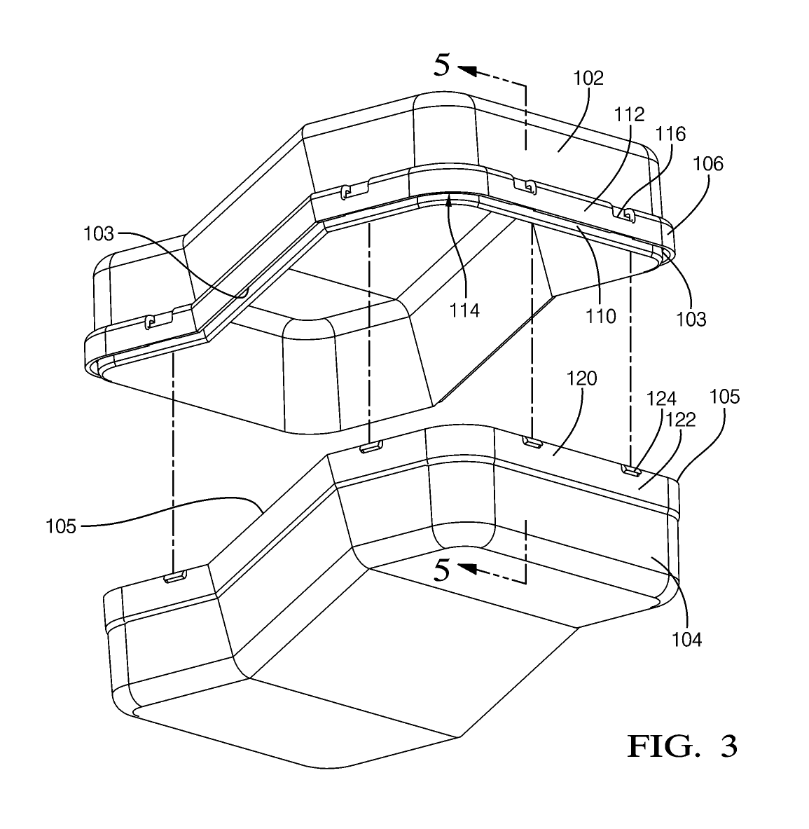

In accordance with a preferred embodiment of this invention, referring to FIGS. 3 through 7, is a compact in-groove snap fastener 100 that includes a tab member 120 having an integral tongue portion 122 that cooperates with groove members 110, 112 to provide a substantially airtight seal and a locking portion 124 that cooperates with an aperture 116 defined in one of the groove members 110, 112 to secure the first housing member 102 to the second housing member 104. The tab member 120 having the tongue portion 122 integral with the locking portion 124 is disposed within a groove 114 defined by the groove members 110, 112, or in groove, allowing for a compact fastener. In other words, the tab member 120 functions both as a tongue and a lock; thereby reducing the number of components required; therefore, resulting in a smaller fastener. The compactness of the in-groove snap fastener 100 offers more packaging space in the vehicle and minimizes the reduction of HVAC housing capacity for improved overall HVAC performance, as well as cost savings from less material usage and reduction in manufacturing complexity.

Shown in FIG. 3 is perspective view of a first housing member 102 spaced apart from a second housing member 104, in which each of the first and second housing members 102, 104 includes a perimeter 103, 105 that defines respective openings. The perimeter 103 of the first housing member 102 corresponds to the perimeter 105 of the second housing member 104 in such a way that the first and second housings 102, 104 may be joined to form a complete or partial housing assembly. Extending from the perimeter 103 of the first housing member 102 in the direction of the second housing member 104 is a first groove member 110 and a second groove member 112 defining a groove 114 therebetween. The second groove member 112 defines a plurality of apertures 116 that are substantially evenly spaced along the perimeter 103 of the first housing member 102. The apertures 116 shown in FIG. 3 are provided on the exterior of the housing. A benefit of providing the apertures 116 on the exterior of the housing is that the locking portions 124 are accessible to allow for separation of the two housing members 102, 104 if the need arises. An alternative embodiment (not shown) is to provide the apertures 116 on the interior of the housing members 102, 104 to prevent access to the locking portion 124; the benefit of which is to prevent intentional disengagement of the in-groove snap fastener 100.

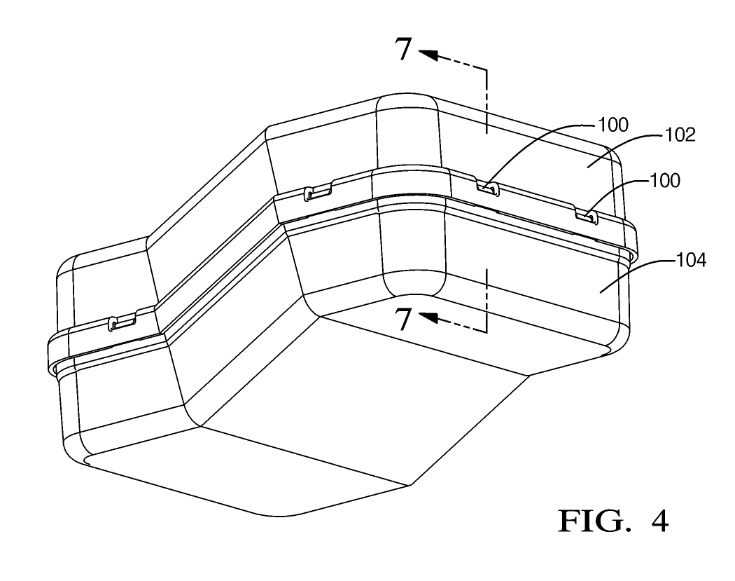

Extending from the perimeter of the second housing member 104 is a tab member 120. The tab member 120 includes a tongue portion 122 circumscribing the perimeter 105 of the second housing member 104, in which the tongue portion 122 is oriented toward and insertable into the groove 114 defined by the first and second groove members 110, 112. The tab member 120 also includes a plurality of locking portions 124 corresponding to the locations of the apertures 116 defined in the second groove member 112 of the first housing member 102. Each of the locking portions 124 securely engages and locks the second housing member 104 to the first housing member 102 as shown in FIG. 4.

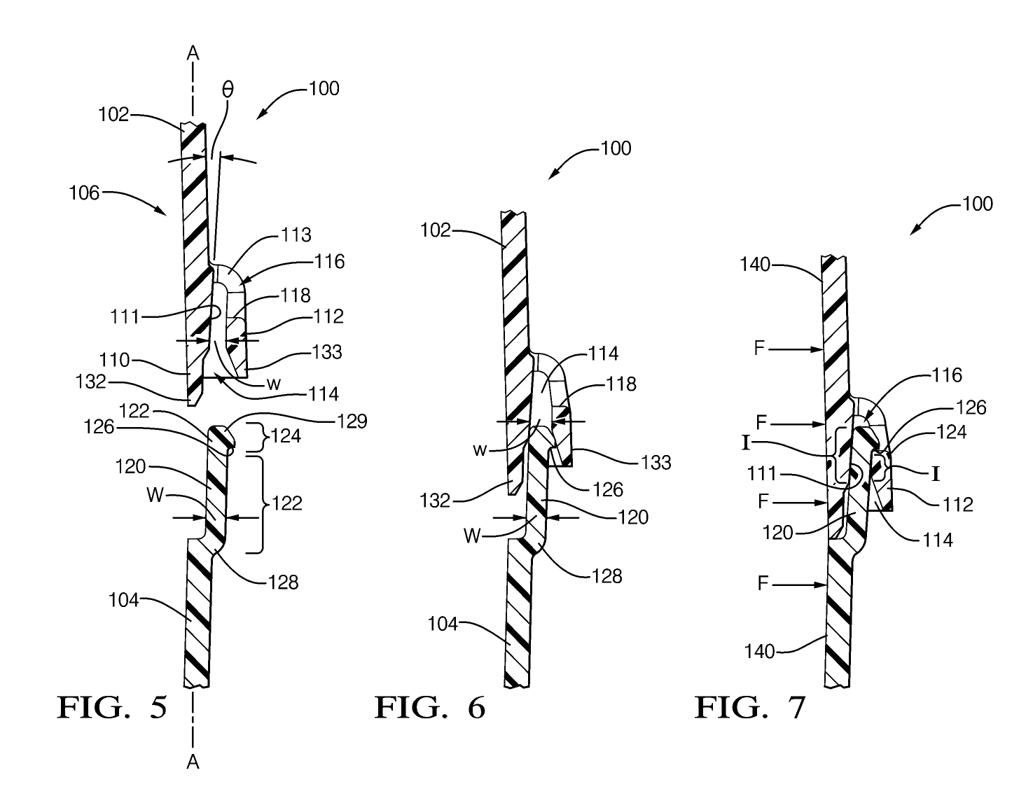

Shown in FIG. 5 is a cross sectional view of FIG. 3 taken along line 5-5 prior to the insertion of the tab member 120 into the groove 114. The first housing member 102 includes an end portion 106 extending along an A-axis and transitioning into a first groove member 110. Extending radially from the end portion 106 is a bridge portion 113 transitioning into a second groove member 112 that extends substantially parallel to the first groove member 110. The first and second groove members 110, 112 define a groove 114 therebetween. The bridge portion 113 of the second groove member 112 defines an aperture 116 having a ledge surface 118 substantially perpendicular to the first groove member 110 and facing in a direction away from the second housing member 104. The first and second groove members 110, 112 each includes a distal end 132, 133 beveled inward toward the groove 114. The first groove member 110 also includes a raised surface 111 oriented toward the second groove member 112. The raised surface 111 is tapered at an angle θ relative the A-axis toward the distal end 132 of the first groove member 110, the significance of which will be discussed in detail below.

Referring to FIGS. 5 and 6, a tab member 120 extends from the second housing member 104 in a direction toward the groove 114 of the first housing member 102. The tab member 120 extends axially from the second housing member 104 or the tab member 120 may in include a tab bridge portion 128 that extends radially from and then transitioning parallel to the second housing member 104. The tab bridge portion 128 provides a radial offset that aligns the tab member 120 with the groove 114 of the first housing member 102. The tab member 120 includes a tongue portion 122 and a distal end defining a locking portion 124. The tab member 120 may also include two parallel tongue portions defining a split tongue. The tongue portion 122 may extend the entire or partial perimeter 105 of the second housing member 104 corresponding with the groove 114 of the first housing member 102. The locations of the locking portions 124 about the perimeter 105 of the second housing member 104 correspond to the locations of the apertures 116 about the perimeter 103 of the first housing member 102.

The locking portion 124 includes a chamfered portion 129 and a flat edge 126 oriented in a direction of the second housing member 104. The flat edge 126 of the locking portion 124 is inserted through the aperture 116 of the second groove member 112 and engages the ledge surface 118 of the aperture 116 as shown in FIG. 7.

Either one or both of the housing members 102, 104 are made of a resilient material such as polypropylene, TFPP, nylon, etc. Shown in FIG. 6 is the tab member 120 of the second housing member 104 being inserted into the groove 114 of the first housing member 102. A portion of the tab member 120 of the second housing member 104 may have a width (W) is that is slightly greater than the width distance (w) between the first groove member 110 and the second groove member 112 in order to provide an interference fit (I) as shown in FIG. 7. The beveled distal ends 132, 133 of the groove members 110, 112 assist in locating and guiding the tab member 120 into the groove 114.

As the locking portion 124 is inserted into the groove 114, either the locking portion 124 or the groove members 110, 112, or both, elastically deforms allowing the tab member 120 to enter the groove 114, in which the tongue portion 122 is interference fitted between the groove members 110, 114. The locking portion 124 of the tab member 120 snaps in a locked position, as shown in FIG. 7, producing a snapping sound to give an audible indication that the tab member 120 is fully inserted and that the housing members 102, 104 are locked together.

Shown in FIG. 7, once the tab member 120 is fully inserted, the flat edge 126 of the locking portion 124 engages the ledge surface 118 of the aperture 116, thereby locking and preventing the tab member 120 from sliding out of the groove 114. Also, each of the first and second housing members 102, 104 includes an interior surface 140 oriented toward the cavity defined by the housing. Under normal operating conditions, the air pressure within the HVAC housing increases above the ambient air pressure. The increased air pressure acts upon the interior surfaces 140 of the first and second housing members 102, 104 and flexes the housing members 102, 104 outward. The outward flexing of the first housing member 102 urges the raised surface 111 of the first groove member 110 sealingly against the tongue portion 122 of the tab member 120, thereby forming a substantial air tight seal between the interior and exterior of the housing. The raised surface 111 having an angle θ wedges the tab portion 120 against the second groove member 112 and the flat edge 126 of the locking portion 120 against the ledge surface 118 of the aperture 116.

The in-groove snap fastener disclosed above has no undercuts in the featured elements and the draft angles of the elements allow the in-groove snap fastener to be molded in a single line of draw. This eliminates the need for slides, lifters, or special tools required for the molding process.

An advantage of the present invention provides for a snap fit feature having a compact exterior dimension while providing for a robust substantially airtight connection between two housing members. Another advantage is that the present invention provides a single fastener having both the functions of a tongue and groove fastener together with that of a snap fastener. Another advantage of the present invention is the reduction in material cost due to the reduction material usage. Yet, another advantage is that the tab member 120 and groove members 110, 112 are within the line of draw of an injection molding process; therefore, the complexity of the mold is reduced as well as the number of operations of the molding process is reduced.

While this invention has been described in terms of the preferred embodiments thereof, it is not intended to be so limited, but rather only to the extent set forth in the claims that follow.

Having described the invention, it is claimed:

1. An in-groove snap fastener for connecting a first housing member to a second housing member, comprising:
a first groove member and a second groove member extending from an end portion of said first housing member defining a groove therebetween, wherein said first groove member includes a raised surface projecting toward said second groove member;
a tab member extending from an end portion of said second housing member toward said groove and engageable with said groove members in such a way that said raised surface of said first groove member urges said tab member against said second groove member, thereby securing said first housing member to said second housing member and forming a substantially air tight seal.

2. The in-groove snap fastener of claim 1, wherein:
said second groove member defines an aperture;
said tab member includes a locking portion engageable with said aperture in such a way that secures tab member to said second groove member.

3. The in-groove snap fastener of claim 2, wherein:
said aperture includes a ledge surface facing in a direction away from said second housing member; and
said locking portion includes a projecting edge insertable through said aperture and engageable with said ledge surface in such away that prevents said tab member from withdrawing from said groove.

4. The in-groove snap fastener of claim 3, wherein:
said second groove member includes an interior surface oriented toward said raised surface of said first groove member;
said tab member includes a tongue portion compressed between said raised surface of said first groove member and said interior surface of said second groove member providing an interference fit of said tab member between said groove members.

5. The in-groove snap fastener of claim 4, wherein:
said groove is axially offset from and substantially parallel with said end portion of first housing member; and
said tab member is axially offset from said second housing member and aligned with said groove.

6. The in-groove snap fastener of claim 5, wherein:
said first groove member is axially aligned with first housing member, and
said second groove member is radially offset from said first housing member and substantially parallel with said first groove member.

7. The in-groove snap fastener of claim 2, wherein said of first and second groove members comprises a resilient material.

8. The in-groove snap fastener of claim 3, wherein said locking portion is located at a distal end of said tab member.

9. The in-groove snap fastener of claim 3, wherein said raised surface of said first groove member is sloped at an angle θ relative to an axis extending through said first housing member portion, wherein said slope of said raised surface urges said locking portion to securely engage said ledge surface of said aperture.

10. The in-groove snap fastener of claim 9, wherein said locking portion of said tab member includes a flat edge adapted to engage said ledge surface of said aperture and a chamfered portion opposite of said flat edge.

11. The in-groove snap fastener of claim 4, wherein said tab member includes a second tab portion substantially parallel to said tab portion defining a split tongue.

12. An in-groove snap fastener for connecting a first housing member to a second housing member, comprising
a first groove member and a second groove member extending from an end portion of said first housing member defining a groove therebetween;
an aperture having a ledge defined in one of said groove members;
a tab member extending from said second housing toward said groove, wherein said tab member is adapted to cooperate with said groove members and said aperture in such a way to secure said first housing member to said second housing member.

13. The in-groove fastener of claim 12, wherein said tab member includes:
a tongue portion having a distal end; and
a locking portion extending from said distal end of said tongue portion,
wherein both said tongue portion and locking portion of said tab member are both insertable within said groove, wherein said tongue member cooperates with groove members to form an interference fit and said locking member cooperates with said ledge of said aperture to secure said first housing member to said second housing member.

14. The in-groove fastener of claim 13, wherein:
one of said groove members includes a raised surface projecting toward other of said groove members; and
said aperture is defined in other of said groove members,
wherein said raised surface urges said locking portion to securely engage said ledge surface of said aperture.

15. A housing assembly comprising a:
a first housing member including a first housing perimeter having a first groove member and a second groove member defining a groove therebetween; and
a second housing member including a second housing perimeter having a tab member adapted to be insertable into said groove;
wherein said second groove member defines an aperture having a ledge;
wherein said tab member includes a tongue portion insertable into said groove and an integral locking portion insertable into said aperture and engageable with said ledge to secure said first housing member to said second housing member.

16. The housing assembly of claim 15, wherein said first groove member includes a raised surface oriented toward said second groove member.

17. The housing assembly of claim 16, wherein said raised surface is tapered at an angle θ relative to an axis through the first groove member.
